(19) United States
(12) Patent Application Publication
(10) Pub. No.: US 2026/0052549 A1
(43) Pub. Date: Feb. 19, 2026

(54) SIDELINK COMMUNICATION METHOD AND APPARATUS

(71) Applicant: Beijing Xiaomi Mobile Software Co., Ltd., Beijing (CN)

(72) Inventor: Qun ZHAO, Beijing (CN)

(21) Appl. No.: 19/102,762

(22) PCT Filed: Aug. 12, 2022
(86) PCT No.: PCT/CN2022/112318

§ 371 Date: Feb. 10, 2025

(51) Int. Cl. H04W 72/25

(52) U.S. Cl. CPC H04W 72/25

(57) ABSTRACT

A sidelink (SL) communication method, performed by user equipment (UE), including: obtaining configuration information, where the configuration information includes time frequency resource information of a first sidelink (SL) resource pool for a first radio access technology (RAT) and a second SL resource pool for a second RAT on a first carrier, the first SL resource pool does not support a physical sidelink feedback channel (PSFCH), the second SL resource pool supports the PSFCH, and the first SL resource pool and the second SL resource pool overlap in a time domain; and not transmitting, according to the configuration information, the PSFCH in a time unit where the first SL resource pool and the second SL resource pool overlap.

### CROSS-REFERENCE TO RELATED APPLICATION

The present application is a U.S. National Stage of International Application No. PCT/CN2022/112318, filed on Aug. 12, 2022, the contents of all of which are incorporated herein by reference in their entireties for all purposes.

### BACKGROUND OF THE INVENTION

With the continuous evolution of a communication technology, more and more users hold mobile devices or Internet of Things (IoT) devices. Mobile network communication technologies, such as sidelink (SL) communication, provide a technical support for the Internet of Things for many application scenarios. At the same time, the continuous emergence of new generation of Internet applications puts forward higher demands for a wireless communication technology.

### SUMMARY OF THE INVENTION

The present disclosure relates to the field of mobile communications, in particular to a sidelink communication method and apparatus.

According to an embodiment of a first aspect of the present disclosure, a sidelink communication method is provided. The sidelink communication method is performed by user equipment (UE). The sidelink communication method includes: obtaining configuration information, where the configuration information includes time frequency resource information of a first sidelink (SL) resource pool for a first radio access technology (RAT) and a second SL resource pool for a second RAT on a first carrier, the first SL resource pool does not support a physical sidelink feedback channel (PSFCH), the second SL resource pool supports the PSFCH, and the first SL resource pool and the second SL resource pool overlap in a time domain; and not transmitting, according to the configuration information, the PSFCH within a time unit where the first SL resource pool and the second SL resource pool overlap in the time domain.

According to an embodiment of a second aspect of the present disclosure, a sidelink communication apparatus is provided. The sidelink communication apparatus includes a transceiving module. The transceiving module is configured to: obtain configuration information, where the configuration information includes time frequency resource information of a first sidelink (SL) resource pool for a first radio access technology (RAT) and a second SL resource pool for a second RAT on a first carrier, the first SL resource pool does not support a physical sidelink feedback channel (PSFCH), the second SL resource pool supports the PSFCH, and the first SL resource pool and the second SL resource pool overlap in a time domain; and not transmit, according to the configuration information, the PSFCH within a time unit where the first SL resource pool and the second SL resource pool overlap in the time domain.

According to an embodiment of a third aspect of the present disclosure, a communication device is provided. The communication device includes: a transceiver; a memory; and a processor, connected with the transceiver and the memory respectively, and configured to control wireless signal receiving and transmitting of the transceiver by executing computer-executable instructions on the memory, so as to implement the method described in the embodiment of the first aspect of the present disclosure.

According to an embodiment of a fourth aspect of the present disclosure, a non-transitory computer readable storage medium storing computer-executable instructions is provided, where the computer-executable instructions, when executed by a processor, implement the method described in the embodiment of the first aspect of the present disclosure.

### BRIEF DESCRIPTION OF DRAWINGS

The above and/or additional aspects and advantages of the present disclosure will become apparent and easy to understand from the description of embodiments with reference to the accompanying drawings.

FIG. 1 is a schematic diagram of an application scenario of a sidelink communication method according to an embodiment of the present disclosure.

FIG. 2 is a schematic flowchart of a sidelink communication method according to an embodiment of the present disclosure.

FIG. 3 is a schematic flowchart of a sidelink communication method according to an embodiment of the present disclosure.

FIG. 4 is a schematic flowchart of a sidelink communication method according to an embodiment of the present disclosure.

FIG. 5 is a schematic diagram of PSFCH and LTE SL not coexisting within one time unit according to an embodiment of the present disclosure.

FIG. 6 is a block diagram of a sidelink communication apparatus according to an embodiment of the present disclosure.

FIG. 7 is a block diagram of a sidelink communication apparatus according to an embodiment of the present disclosure.

FIG. 8 is a schematic structural diagram of a communication apparatus according to an embodiment of the present disclosure.

FIG. 9 is a schematic structural diagram of a chip according to an embodiment of the present disclosure.

### DETAILED DESCRIPTION OF THE INVENTION

Embodiments of the present disclosure are described below in detail. Examples of the embodiments are shown in accompanying drawings. The same or similar reference numbers represent the same or similar elements or elements with the same or similar functions from beginning to end. The embodiments described below with reference to the accompanying drawings are merely examples, aim to explain the present disclosure, and cannot be understood as limitation to the present disclosure.

With a rapid development of a mobile communication technology, an Internet of Things technology has become an inevitable trend in the future development of a communication network, and a sidelink communication technology with more friendly performance has emerged based on the 3rd generation partnership project (3GPP) standard. The continuous emergence of new generation Internet applications (such as vehicle to everything (V2X)) puts forward higher demands for a wireless communication technology, which drives continuous evolution of the wireless communication technology to meet needs of the applications.

In order to better support Internet of Vehicles communication, during transition between the third generation (3G) mobile communication technology and the fourth generation (4G) mobile communication technology, long term evolution (LTE) V2X is developed in a LTE Release 14 to support communication between Internet of Vehicles devices (such as vehicle to vehicle, vehicle to people, and vehicle to roadside node) through a sidelink (SL). In a subsequent Release 15, the LTE V2X technology is further enhanced to support functions such as carrier aggregation. After the Release 15 of a fifth generation (5G) new radio (NR) technology in the 5G mobile communication technology is developed, 3GPP initiates the use of an NR interface to support the Internet of Vehicles communication. In a Release 16, 5G SL is completed to support sidelink communication between the Internet of Vehicles devices through the NR technology. Due to different physical layer designs of LTE and NR, sidelink communication between LTE V2X and NR V2X devices is not possible.

In addition, due to a relatively long upgrading time of vehicles, a coexistence issue between the Internet of Vehicles devices supporting the LTE V2X and the Internet of Vehicles devices supporting the NR V2X needs to be considered. In the Release 16, a situation where the LTE V2X and the NR V2X operate on different carrier frequencies is merely considered. In a recent 3GPP Release 18 discussion, the coexistence situation of the LTE V2X and the NR V2X operating on a same carrier frequency is discussed, and it is proposed to support that two types of V2X technologies can dynamically share a time-frequency resource on the same carrier frequency. Due to the LTE V2X being a system developed before the NR V2X, the focus needs to be on improving the NR V2X to support sharing of frequency spectrum resources.

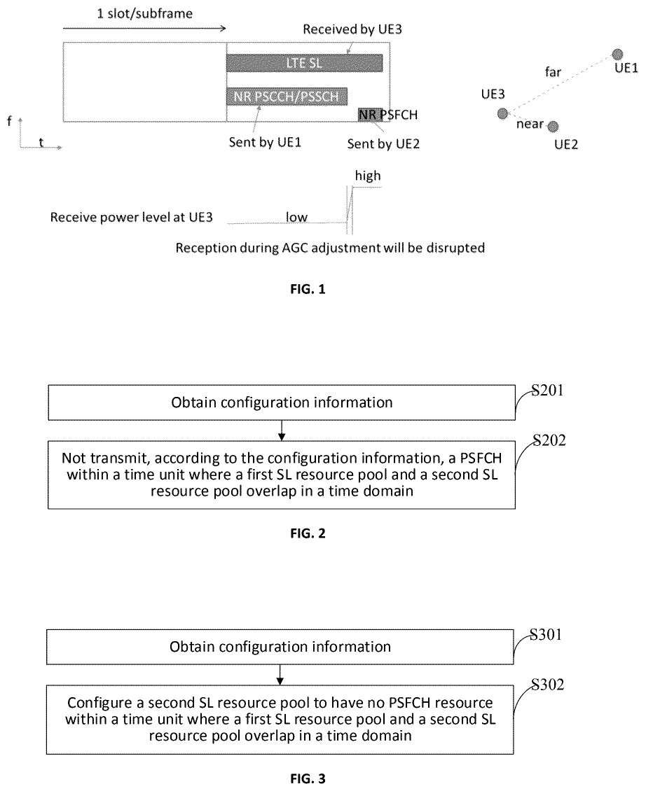

However, in related art, an NR SL resource pool supports a physical sidelink feedback channel (PSFCH), for example, the PSFCH is configured in a case that hybrid automatic repeat request feedback information (HARQ-ACK) is supported, while an LTE SL resource pool does not support the PSFCH. Since transmitting UE for transmission of an NR PSCCH/PSSCH and the PSFCH may be different in one time unit, in a case that UE for the LTE V2X performs LTE SL transmission in the time unit with NR PSFCH resources, power of received signals of a receiving UE for the LTE V2X on different orthogonal frequency division multiplexing symbols in the same time unit may undergo drastic changes, which can cause an auto gain control (AGC) of the receiving UE for the LTE V2X to exceed an adjustment range and affect reception performance of the LTE V2X, as shown in FIG. 1.

In an application scenario, in a case that the UE supports two RATs, for example, in a case that the UE supports both the LTE SL technology and the NR SL technology, during sidelink communication between the pieces of UE, such as during communication with other pieces of UE supporting the LTE SL technology through an LTE communication technology or during communication with other pieces of UE supporting the NR SL technology through the NR communication technology, SL resource pool configurations for the two RATs need to be considered simultaneously to avoid problems such as communication performance reduction caused by possible conflicts between the two RATs in different application scenarios.

Therefore, in the current application of the SL technology, a problem of coexistence of two radio access technologies (RAT) on the same carrier has not been solved.

To this end, the present disclosure provides a sidelink communication method and apparatus, which provides that user equipment (UE) achieves, through a resource pool configuration and transmission scheme, SL communication in a case that two RATs coexist, avoiding communication interference possibly caused by coexistence of two RATs.

The sidelink communication method and apparatus according to the present disclosure are introduced below in detail with reference to the accompanying drawings.

FIG. 2 shows a schematic flowchart of a sidelink communication method according to an embodiment of the present disclosure. The method may be performed by user equipment (UE). In the present disclosure, the UE includes, but is not limited to, an intelligent terminal, a cellular phone, a wireless device, a handheld set, a mobile unit, a vehicle, an on board device, etc.

In the embodiment of the present disclosure, the scheme provided by the present disclosure may be used for fifth generation (5G) and subsequent communication technologies, such as a 5G-advanced mobile communication technology and a sixth generation (6G) mobile communication technology, which is not limited in the present disclosure.

As shown in FIG. 2, the method may include steps S201 and S202.

In step S201, configuration information is obtained.

In the embodiment of the present disclosure, the configuration information refers to resource pool configuration information for the UE. In an example, the configuration information includes time frequency resource information of a first sidelink (SL) resource pool for a first radio access technology (RAT) and a second SL resource pool for a second RAT on a first carrier.

In the embodiment of the present disclosure, the first RAT may be a long term evolution (LTE) technology, and the first SL resource pool for the first RAT may be an LTE SL resource pool. The second RAT may be a new radio (NR) technology, and the second SL resource pool for the second RAT may be an NR SL resource pool.

It may be understood that the first SL resource pool does not support a physical sidelink feedback channel (PSFCH), while the second SL resource pool supports the PSFCH.

A scenario discussed in the embodiment of the present disclosure is that LTE SL and NR SL coexist on a same carrier, and the first SL resource pool and the second SL resource pool overlap in a time domain.

It is to be understood that the UE may configure its resource pool based on the configuration information. The resource pool configuration described in the present disclosure refers to a configuration for the second SL resource pool, namely the NR SL resource pool. In addition, the present disclosure does not limit whether the UE is receiving UE or transmitting UE. It is to be understood that for sidelink communication between the pieces of UE, the configuration for the UE is aligned between the receiving UE and the transmitting UE.

In addition, a manner for the UE to obtain the configuration information may be to obtain from pre-configuration for the UE, such as obtaining the configuration information by reading pre-configured data stored in a chip of the UE. Alternatively, in some embodiments of the present disclosure, a manner for the UE to obtain the configuration information may be to receive downlink control information transmitted by a network device and to obtain configuration data from the downlink control information. The present disclosure does not limit the manner for the UE to obtain the configuration information.

In an application scenario of 5G, the network device may be a 5G radio access network (NG-RAN) node, such as gNB or ng-eNB, where the gNB may be used for independent networking, while the ng-eNB may be used for downward compatibility with a 4G network to adapt to application demands of different core networks. The use cases depend on the application scenario and are not limited in the disclosure.

In step S202, the PSFCH is not transmitted, according to the configuration information, within a time unit where the first SL resource pool and the second SL resource pool overlap in the time domain.

It may be understood that in related art, the physical sidelink feedback channel (PSFCH) may be configured in a case that the NR SL resource pool supports hybrid automatic repeat request feedback information (HARQ-ACK) or an Inter-UE coordination scheme 2. According to the configuration for the resource pool, the PSFCH may appear in cycles of 1, 2, or 4 logical time units. In one time unit containing the PSFCH, the PSFCH is time-division multiplexed with a physical sidelink control channel (PSCCH)/physical sidelink share channel (PSSCH). The PSFCH occupies the last four available sidelink orthogonal frequency division multiplexing (OFDM) symbols of one time unit, including a guard symbol between the PSCCH/PSSCH and the PSFCH, an auto gain control (AGC) symbol of the PSFCH, a symbol for a PSFCH signal, and a guard symbol after the PSFCH. However, the LTE SL resource pool does not support the PSFCH, and transmission of the PSCCH/PSSCH will occupy other OFDM symbols except for the last symbol of one time unit (such as a subframe).

In the embodiment of the present disclosure, the first SL resource pool and the second SL resource pool overlap in the time domain, in other words, the LTE SL and the NR SL coexist on the same carrier. Since transmitting UE for transmission of the NR PSCCH/PSSCH and the PSFCH may be different in one time unit, in a case that UE for the LTE V2X performs LTE SL transmission in the time unit with NR PSFCH resources, power of received signals of receiving UE for the LTE V2X on different orthogonal frequency division multiplexing symbols in the same time unit may undergo drastic changes, which can cause an AGC of the receiving UE for the LTE V2X to exceed an adjustment range and affect reception performance of the LTE V2X.

Thus, in the embodiment of the present disclosure, the UE does not transmit, according to the configuration information, the PSFCH within the time unit where the first SL resource pool and the second SL resource pool overlap in the time domain. In other words, the UE does not transmit or receive the PSFCH within the time unit where the NR SL resource pool and the LTE SL resource pool overlap in the time domain, so as to avoid the problem of reception performance reduction of the LTE V2X due to the presence of the NR PSFCH.

The time unit described in the embodiment of the present disclosure may include a slot, a subframe, a frame, a subslot, an OFDM symbol, etc., which are not limited in the present disclosure.

To sum up, according to the sidelink communication method provided by the present disclosure, the UE obtains the configuration information, where the configuration information includes the time frequency resource information of the first SL resource pool for the first RAT and the second SL resource pool for the second RAT on the first carrier, the first SL resource pool does not support the physical sidelink feedback channel (PSFCH), the second SL resource pool supports the PSFCH, and the first SL resource pool and the second SL resource pool overlap in the time domain; and the UE does not transmit the PSFCH, according to the configuration information, within the time unit where the first SL resource pool and the second SL resource pool overlap in the time domain. The present disclosure provides a basis for the UE to use the SL for communication services with regard to the coexistence situation of two RATs operating on the same carrier frequency, thus communication interference possibly caused by the coexistence of two RATs is avoided.

Based on the embodiment shown in FIG. 2, FIG. 3 shows a schematic flowchart of a sidelink communication method according to an embodiment of the present disclosure. The method may be performed by UE. As shown in FIG. 3, the method may include steps S301 and S302.

In step S301, configuration information is obtained.

In the embodiment of the present disclosure, the configuration information includes time frequency resource information of a first SL resource pool for a first RAT and a second SL resource pool for a second RAT on a first carrier. The first SL resource pool does not support a PSFCH, while the second SL resource pool supports the PSFCH. The first SL resource pool and the second SL resource pool overlap in a time domain. In other words, LTE SL and NR SL coexist on a same carrier.

In the embodiment of the present disclosure, for example, the first RAT may be a long term evolution (LTE) technology, and the first SL resource pool for the first RAT may be an LTE SL resource pool. The second RAT may be a new radio (NR) technology, and the second SL resource pool for the second RAT may be an NR SL resource pool.

The principle of step S301 in this embodiment is the same as step S201 in the embodiment of the disclosure, and other corresponding explanations may refer to step S201, which will not be repeated.

In step S302, the second SL resource pool is configured to have no PSFCH resource within a time unit where the first SL resource pool and the second SL resource pool overlap in the time domain.

In the embodiment of the present disclosure, the problem addressed in the present disclosure is to avoid reception performance reduction of LTE V2X due to the presence of the NR PSFCH in a case that LTE SL and NR SL coexist on the same carrier. Thus, since the NR SL resource pool configuration supports the PSFCH, in order to achieve non transmission of the PSFCH within the time unit where the first SL resource pool and the second SL resource pool overlap in the time domain, the UE may configure the second SL resource pool to have no PSFCH resource within the time unit where the first SL resource pool and the second SL resource pool overlap in the time domain.

It is to be noted that for the NR SL resource pool, in a case that the UE needs to use the NR SL resource pool for transmitting demands of hybrid automatic repeat request feedback information (HARQ-ACK) or inter-UE coordination information indicating a potential conflict, transmission may be achieved by carrying the HARQ-ACK feedback information or the information indicating the potential conflict through a physical sidelink control channel (PSCCH) or a physical sidelink share channel (PSSCH).

Thus, since PSFCH resources are not configured in the NR SL resource pool, there is no need to transmit the PSFCH within the time unit where the LTE SL resource pool and the NR SL resource pool overlap in the time domain, so as to avoid communication interference possibly caused by coexistence of two RATs.

To sum up, according to the sidelink communication method provided by the present disclosure, the UE may obtain the configuration information and configure the second SL resource pool to have no PSFCH resource within the time unit where the first SL resource pool and the second SL resource pool overlap in the time domain, so as to achieve the non-transmission of the PSFCH within the time unit where the first SL resource pool and the second SL resource pool overlap in the time domain. A basis is provided for the UE to use a sidelink for communication services with regard to the coexistence situation of two RATs operating on the same carrier frequency, thus communication interference possibly caused by coexistence of two RATs is avoided.

Based on the embodiment shown in FIG. 2, FIG. 4 shows a schematic flowchart of a sidelink communication method according to an embodiment of the present disclosure. The method may be performed by UE. As shown in FIG. 4, the method may include steps S401 and S402.

In step S401, configuration information is obtained.

In the embodiment of the present disclosure, the configuration information includes time frequency resource information of a first SL resource pool for a first RAT and a second SL resource pool for a second RAT on a first carrier. The first SL resource pool does not support a PSFCH, while the second SL resource pool supports the PSFCH. The first SL resource pool and the second SL resource pool overlap in a time domain. In other words, LTE SL and NR SL coexist on a same carrier.

In the embodiment of the present disclosure, for example, the first RAT may be a long term evolution (LTE) technology, and the first SL resource pool for the first RAT may be an LTE SL resource pool. The second RAT may be a new radio (NR) technology, and the second SL resource pool for the second RAT may be an NR SL resource pool.

The principle of step S401 in this embodiment is the same as step S201 in the embodiment of the disclosure, and other corresponding explanations may refer to step S201, which will not be repeated.

In step S402, PSFCH transmission in the second SL resource pool is canceled within the time unit where the first SL resource pool and the second SL resource pool overlap in the time domain.

In the embodiment of the present disclosure, the problem addressed in the present disclosure is to avoid reception performance reduction of LTE V2X due to the presence of the NR PSFCH in a case that LTE SL and NR SL coexist on the same carrier. Thus, since the NR SL resource pool configuration supports the PSFCH, different from the example shown in FIG. 3 where the PSFCH is not configured, this embodiment discusses a situation where the NR SL resource pool is configured with the PSFCH.

For example, the UE may determine, according to the NR SL resource pool configuration, a time unit where NR PSFCH time-frequency resources exist. Then, the UE cancels the PSFCH transmission in the second SL resource pool within the time unit where the first SL resource pool and the second SL resource pool overlap in the time domain.

It is to be understood that the “cancel. transmission” described in this embodiment is a implementation of “not transmission” in the embodiment shown in FIG. 2. Below is a explanation of this embodiment.

In an implementation, canceling the PSFCH transmission in the second SL resource pool includes: abandoning transmitting of the PSFCH; and discarding information carried by the PSFCH.

In other words, for the NR SL resource pool, in a case that the UE needs to use the NR SL resource pool for transmitting demands of hybrid automatic repeat request feedback information (HARQ-ACK) or inter-UE coordination information indicating a potential conflict, the UE directly abandons the transmission of the HARQ-ACK feedback information or the information indicating the potential conflict, and discards the data without processing, so as to avoid the potential conflict caused by the PSFCH transmission.

In another implementation, canceling the PSFCH transmission in the second SL resource pool includes: transmitting a physical sidelink control channel (PSCCH) or a physical sidelink share channel (PSSCH) according to absence of PSFCH resources.

In other words, the UE determines a time unit slot n with the NR PSFCH time-frequency resources according to the NR SL resource pool configuration. In a case that time-frequency resources of the LTE SL resource pool exist on the slot n, the UE ignores the PSFCH resources on this time unit, abandons the transmission of the PSFCH and information carried by the PSFCH, and merely realizes the transmission of PSCCH or PSSCH resources according to the absence of the PSFCH resources.

It may be understood that in a case that the UE needs to transmit or receive the PSCCH/PSSCH on the slot n, an end OFDM symbol of the PSCCH/PSSCH is extended backwards by three symbols, namely, including a guard symbol between the PSCCH/PSSCH and the PSFCH, an AGC symbol of the PSFCH, and an OFDM symbol of a PSFCH signal. Sizes and positions of frequency-domain resources occupied by the PSCCH/PSSCH transmission remain unchanged on these three symbols to achieve PSCCH/PSSCH transmission.

In another implementation, canceling the PSFCH transmission in the second SL resource pool includes: abandoning receiving of the PSFCH, and setting received information carried by the PSFCH as a specific value.

In other words, in a case that the UE needs to receive information on the time unit slot n with the NR PSFCH time-frequency resources, the UE needs to set the received information carried by the PSFCH as the specific value.

For example, the specific value is ACK in a case that the PSFCH is used to carry hybrid automatic repeat request feedback information (HARQ-ACK). That is, in a case that the PSFCH carries the HARQ-ACK, the UE abandons the reception of the PSFCH and performs processing as the ACK is received.

For another example, the specific value does not indicate that collision occurs in a case that the PSFCH is used to carry inter-UE coordination information. That is, in a case that the UE receives on the slot n the PSFCH carrying the inter-UE coordination information indicating a potential conflict (or collision), the UE abandons the reception of the PSFCH and performs processing as there is no potential conflict.

In another implementation, canceling the PSFCH transmission in the second SL resource pool includes: abandoning transmitting of the PSFCH, and transmitting information carried by the PSFCH through a physical layer channel multiplexed with the physical sidelink control channel (PSCCH) or the physical sidelink share channel (PSSCH) in a frequency domain.

In other words, the UE may achieve the transmission of the information carried by the PSFCH by changing a multiplexing manner between the PSFCH and the PSCCH/PSSCH in NR signals. That is to say, in a case that the UE needs to use the NR SL resource pool for transmitting demands of the hybrid automatic repeat request feedback information (HARQ-ACK) or the inter-UE coordination information indicating the potential conflict, transmission may be achieved by carrying the HARQ-ACK feedback information or the information indicating the potential conflict through the physical layer channel multiplexed with the physical sidelink control channel (PSCCH) or the physical sidelink share channel (PSSCH) in the frequency domain.

In an example, the PSFCH and the PSCCH/PSSCH occupy the same OFDM symbols within the same time unit and are multiplexed in a manner of frequency-division multiplexing (FDM).

In another implementation, canceling the PSFCH transmission in the second SL resource pool includes: abandoning transmitting of the PSFCH, and transmitting the information carried by the PSFCH through the physical sidelink control channel (PSCCH) or the physical sidelink share channel (PSSCH).

In other words, for the NR SL resource pool, in a case that the UE needs to use the NR SL resource pool for transmitting demands of the HARQ-ACK or the inter-UE coordination information, the transmission may be achieved through carrying by the PSCCH or the PSSCH the HARQ-ACK feedback information or the information indicating the potential conflict.

To sum up, according to the sidelink communication method provided by the present disclosure, the UE may obtain the configuration information and cancel the transmission of the PSFCH resources within the time unit where the first SL resource pool and the second SL resource pool overlap in the time domain, so as to achieve the non-transmission of the PSFCH within the time unit where the first SL resource pool and the second SL resource pool overlap in the time domain. A basis is provided for the UE to use a sidelink for communication services with regard to the coexistence situation of two RATs operating on the same carrier frequency, thus communication interference possibly caused by coexistence of two RATs is avoided.

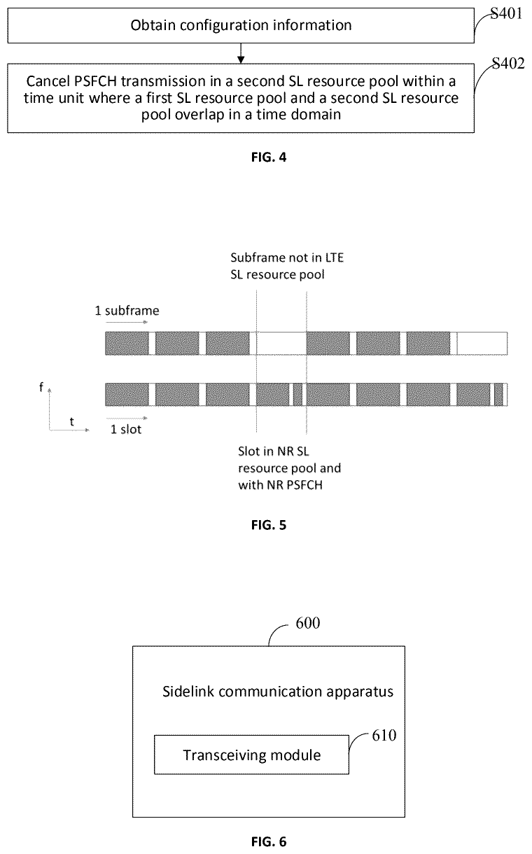

It may be understood that any scheme that can avoid reception performance reduction of LTE V2X due to the presence of the NR PSFCH in a case that LTE SL and NR SL coexist on the same carrier falls within the scope of protection of the present disclosure. In some implementations of the present disclosure, in a case that the NR SL and the LTE SL coexist on the same carrier, the UE may further ensure that the NR SL resource pool configuration and the LTE SL resource pool configuration do not have LTE SL time-frequency resources on the slot n after determining the slot n with the NR PSFCH time-frequency resources according to the NR SL resource pool configuration, which can also achieve the effect of the present disclosure. In other words, to avoid the coexistence situation of the PSFCH and the LTE SL in the same time unit, the LTE SL time unit does not exist on the time unit where the PSFCH resources exist in the NR SL resource pool, as shown in FIG. 5.

Thus, the present disclosure avoids the coexistence situation of the PSFCH and the LTE SL within one time unit through the resource pool configuration, or in a manner of scarifying the transmission and reception of the NR PSFCH, or changing a multiplexing relationship between the NR PSFCH and the PSCCH/PSSCH, or changing a carrying channel of the information carried by the NR PSFCH, a communication interference problem in a case that the LTE SL and the NR SL coexist on the same carrier is solved, and reception performance reduction of the LTE V2X caused by the presence of the NR PSFCH is avoided. The various implementations provided by the present disclosure enhance the flexibility of resource configuration for solving related technical problems.

In the above embodiments provided by the present application, the methods provided by the embodiments of the present application are introduced from the perspective of the user equipment. In order to implement the various functions in the methods provided by the embodiments of the present disclosure, the user equipment may include a hardware structure and a software module, and the various functions may be implemented in the form of the hardware structure, the software module, or the hardware structure plus the software module. One of the various functions may be executed in the form of the hardware structure, the software module, or the hardware structure plus the software module.

Corresponding to the sidelink communication method provided by the embodiments of the disclosure, the present disclosure further provides a sidelink communication apparatus. Because the sidelink communication apparatus provided by the embodiment of the present disclosure corresponds to the sidelink communication methods provided by the embodiments of the disclosure, the implementation of the sidelink communication method is also applicable to the sidelink communication apparatus provided by the embodiment of the present disclosure, which will not be described in detail in this embodiment.

FIG. 6 is a schematic structural diagram of a sidelink communication apparatus 600 provided by an embodiment of the present disclosure. The sidelink communication apparatus 600 may be applied to user equipment (UE).

As shown in FIG. 6, the apparatus 600 may include a transceiving module 610, configured to: obtain configuration information, where the configuration information includes time frequency resource information of a first sidelink (SL) resource pool for a first radio access technology (RAT) and a second SL resource pool for a second RAT on a first carrier, the first SL resource pool does not support a physical sidelink feedback channel (PSFCH), the second SL resource pool supports the PSFCH, and the first SL resource pool and the second SL resource pool overlap in a time domain; and not transmit, according to the configuration information, the PSFCH within a time unit where the first SL resource pool and the second SL resource pool overlap in the time domain.

According to the sidelink communication apparatus provided by the present disclosure, the configuration information is obtained, where the configuration information includes the time frequency resource information of the first SL resource pool for the first RAT and the second SL resource pool for the second RAT on the first carrier, the first SL resource pool does not support the physical sidelink feedback channel (PSFCH), the second SL resource pool supports the PSFCH, and the first SL resource pool and the second SL resource pool overlap in the time domain; and the PSFCH is not transmitted, according to the configuration information, within the time unit where the first SL resource pool and the second SL resource pool overlap in the time domain. The present disclosure provides a basis for the UE to use the sidelink for communication services with regard to the coexistence situation of two RATs operating on the same carrier frequency, thus communication interference possibly caused by coexistence of two RATs is avoided.

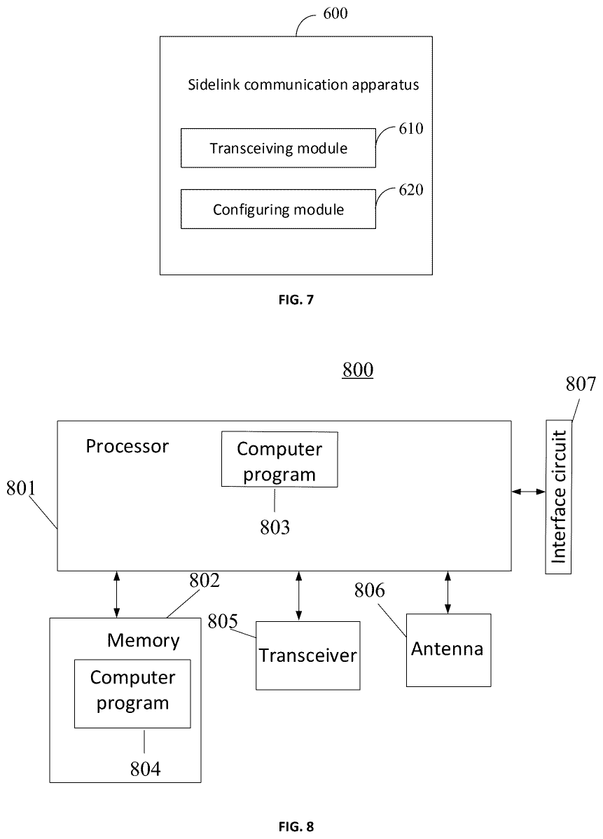

In some embodiments, based on FIG. 6, as shown in FIG. 7, the apparatus 600 further includes a configuring module 620, configured to configure the second SL resource pool to have no PSFCH resource within the time unit where the first SL resource pool and the second SL resource pool overlap in the time domain.

In some embodiments, the transceiving module 610 is further configured to cancel PSFCH transmission in the second SL resource pool, within the time unit where the first SL resource pool and the second SL resource pool overlap in the time domain.

In some embodiments, the transceiving module 610 is further configured to abandon transmitting of the PSFCH, and discard information carried by the PSFCH.

In some embodiments, the transceiving module 610 is further configured to transmit a physical sidelink control channel (PSCCH) or a physical sidelink share channel (PSSCH) according to absence of PSFCH resources.

In some embodiments, the transceiving module 610 is further configured to abandon receiving of the PSFCH, and set received information carried by the PSFCH as a specific value.

In some embodiments, the transceiving module 610 is further configured to set the specific value as ACK in a case that the PSFCH is used to carry hybrid automatic repeat request feedback information (HARQ-ACK); or, set the specific value as not indicating that collision occurs in a case that the PSFCH is used to carry inter-UE coordination information.

In some embodiments, the transceiving module 610 is further configured to abandon transmitting of the PSFCH and transmitting information carried by the PSFCH through a physical layer channel multiplexed with a physical sidelink control channel (PSCCH) or a physical sidelink share channel (PSSCH) in a frequency domain.

In some embodiments, the transceiving module 610 is further configured to abandon transmitting of the PSFCH and transmitting information carried by the PSFCH through a physical sidelink control channel (PSCCH) or a physical sidelink share channel (PSSCH).

In some embodiments, the transceiving module 610 is further configured to obtain the configuration information by reading pre-configured data for the UE; or obtain the configuration information by receiving downlink control information transmitted by a network device.

Thus, the present disclosure avoids the coexistence situation of the PSFCH and the LTE SL within one time unit through the resource pool configuration, or in a manner of scarifying the transmission and reception of the NR PSFCH, or changing a multiplexing relationship between the NR PSFCH and the PSCCH/PSSCH, or changing a carrying channel of the information carried by the NR PSFCH, a communication interference problem in a case that the LTE SL and the NR SL coexist on the same carrier is solved, and reception performance reduction of the LTE V2X caused by the presence of the NR PSFCH is avoided. The various implementations provided by the present disclosure enhance the flexibility of resource configuration for solving related technical problems.

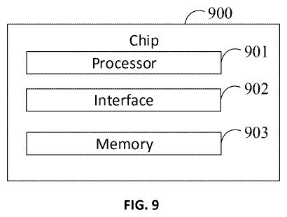

Please refer to FIG. 8, and FIG. 8 is a schematic structural diagram of a communication apparatus 800 provided by an embodiment of the present disclosure. The communication apparatus 800 may be a network device, may also be user equipment, may also be a chip, a system on a chip, or a processor that supports the network device to implement the methods of the disclosure, and may further be a chip, a system on a chip, or a processor that supports the user equipment to implement the methods of the disclosure. This apparatus may be used for implementing the methods described in the method embodiments, which may refer to illustration in the method embodiments.

The communication apparatus 800 may include one or more processors 801. The processor 801 may be a general-purpose processor or a dedicated processor. For example, the processor 801 may be a baseband processor or a central processing unit. The baseband processor may be used for processing a communication protocol and communication data, and the central processing unit may be used for controlling the communication apparatus 800 (such as a base station, a baseband chip, a terminal, a terminal chip, and a distributed unit (DU) or central unit (CU)), executing a computer program, and processing data from the computer program.

In an example, the communication apparatus 800 may further include one or more memories 802 on which a computer program 804 can be stored, and the processor 801 executes the computer program 804 to cause the communication apparatus 800 to execute the methods described in the method embodiments. In an example, the memory 802 may further store data. The communication apparatus 800 and the memory 802 may be arranged separately or integrated together.

In an example, the communication apparatus 800 may further include a transceiver 805 and an antenna 806. The transceiver 805 may be referred to as a transceiving unit, a transceiving machine, or a transceiving circuit, etc., used for achieving a transceiving function. The transceiver 805 may include a receiver and a transmitter. The receiver may be referred to as a receiving machine or a receiving circuit, for achieving a reception function. The transmitter may be referred to as a transmitting machine or a transmitting circuit, for achieving a transmitting function.

In an example, the communication apparatus 800 may further include one or more interface circuits 807. The interface circuit 807 is configured to receive code instructions and transmitting the code instructions to the processor 801. The processor 801 runs the code instructions to cause the communication apparatus 800 to execute the method described in the method embodiments.

In one implementation, the processor 801 may include a transceiver (not shown) for implementing receiving and transmitting functions. For example, the transceiver may be a transceiving circuit, an interface, or an interface circuit. The transceiving circuit, interface, or interface circuit used for achieving the receiving and transmitting functions may be separate or integrated together. The transceiving circuit, interface, or interface circuit can be used for reading and writing codes/data, or the transceiving circuit, interface, or interface circuit may be used for signal transmission or transferring.

In one implementation, the processor 801 may store a computer program 803. The computer program 803 runs on the processor 801, to cause the communication apparatus 800 to execute the methods described in the method embodiments. The computer program 803 may be solidified in the processor 801, in which case the processor 801 may be implemented by hardware.

In one implementation, the communication apparatus 800 may include a circuit, and the circuit may achieve the functions of transmitting, receiving, or communicating in the method embodiments. The processor and the transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, and the like. The processor and the transceiver may also be manufactured using various IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The communication apparatus 800 described in the embodiments may be a network device or user equipment, but the scope of the communication apparatus 800 described in the present disclosure is not limited to this. The structure of the communication apparatus 800 may be not limited by the figure. The communication apparatus 800 may be an independent device or may be part of a larger device. For example, the communication apparatus 800 may be:
(1) an independent integrated circuit (IC), or a chip, or a chip system or a subsystem;
(2) a set with one or more ICs, for example, the set of ICs includes a storage component for storing data and a computer program;
(3) an ASIC, such as a modem;
(4) a module that can be embedded in other devices;
(5) a receiving machine, a terminal, an intelligent terminal, a cellular phone, a wireless device, a handheld machine, a mobile unit, an on board device, a network device, a cloud device, an artificial intelligence devices, etc.; and
(6) others and so on.

For a case that the communication apparatus 800 may be a chip or a chip system, please refer to a schematic structural diagram of a chip shown in FIG. 9. The chip 900 shown in FIG. 9 includes a processor 901 and an interface 902. A number of the processor 901 may be one or more, and a number of the interfaces 902 may be more than one.

In an example, the chip 900 further includes a memory 903, and the memory 903 is configured to store needful computer program and data.

The skilled in the art can further understand that various illustrative logical blocks and steps listed in the embodiment of the present disclosure may be implemented through electronic hardware, computer software, or a combination of the two. Whether such functions are implemented through hardware or software depends on the specific application and design demands of the overall system. The skilled in the art can use various methods to achieve the described functions for each specific application, but such implementation is not to be understood as exceeding the scope of protection of the embodiment of the present disclosure.

The present disclosure further provides a non-transitory computer readable storage medium on which instructions are stored, and the instructions, when executed by a computer, implement the functions of any of the method embodiments.

The present disclosure further provides a computer program product, and the computer program product, when executed by a computer, implements the functions of any of the method embodiments.

In the embodiments, it can be fully or partially implemented through software, hardware, firmware, or any combination of them. When implemented using the software, it can be fully or partially implemented in a form of the computer program product. The computer program product includes one or more computer programs. When loading and executing the computer program on the computer, processes or functions described according to the embodiment of the present disclosure are fully or partially generated. The computer may be a general-purpose computer, a dedicated computer, a computer network, or other programmable apparatuses. The computer program may be stored in a non-transitory computer-readable storage medium or transmitted from one non-transitory computer-readable storage medium to another. For example, the computer program may be transmitted from a website, a computer, a server or a data center to another website, computer, server, or data center through a wired (such as a coaxial cable, an optical fiber, a digital subscriber line (DSL)) or wireless (such as infrared, wireless, and microwave) mode. The non-transitory computer-readable storage medium may be any available medium that the computer can access, or a data storage device such as a server or a data center that is integrated by one or more available media. The available medium may be a magnetic medium (such as a floppy disk, a hard drive, and a magnetic tape), an optical medium (such as a high-density digital video disc (DVD)), or a semiconductor medium (such as a solid state disk (SSD)), etc.

Those ordinarily skilled in the art can understand that the first, second, and other numerical numbers involved in the present disclosure are merely differentiation for the convenience of description, and are not intended to limit the scope of the embodiment of the present disclosure, but also indicate the sequential order.

Term “at least one” in the present disclosure can further be described as “one or a plurality of”, and “a plurality of” may be two, three, four, or more, which is not limited in the present disclosure. In the embodiment of the present disclosure, for a technical feature, the technical features described in the technical feature are distinguished by “first”, “second”, “third”, “A”, “B”, “C”, and “D”, and the technical features described by “first”, “second”, “third”, “A”, “B”, “C”, and “D”have no any sequential order or order of size.

As used in the present disclosure, terms “machine-readable medium” and “computer-readable medium” refer to any computer program product, device, and/or apparatus (e.g., a magnetic disk, an optical disk, a memory, a programmable logic device (PLD)) used to provide machine instructions and/or data to a programmable processor, including a machine-readable medium that receives machine instructions as a machine-readable signal. The term “machine-readable signal” refers to any signal used to provide the machine instructions and/or the data to the programmable processor.

The system and technology described in the disclosure may be implemented in a computing system that includes backend components (such as serving as a data server), or a computing system that includes middleware components (such as an application server), or a computing system that includes frontend components (such as a user computer with a graphical user interface or a web browser, where the user can interact with the implementation of the system and the technology described in the disclosure through the graphical user interface or the web browser), or a computing system that includes any combination of such backend components, middleware components, or frontend components. The components of the system may be interconnected through any form or medium of digital data communication (such as a communication network). Examples of the communication network include a local area network (LAN), a wide area network (WAN) and the Internet.

A computer system may include a client and a server. The client and the server are generally away from each other and usually interact through the communication network. A relationship of the client and the server is generated through computer programs running on a corresponding computer and mutually having a client-server relationship.

It is to be understood that various forms of flows shown in the disclosure may be used to reorder, increase or delete the steps. For example, all the steps recorded in the present disclosure may be executed in parallel, may also be executed sequentially or in different sequences, as long as the expected result of the technical scheme disclosed by the present disclosure may be implemented, which is not limited in the disclosure.

Furthermore, it is to be understood that the various embodiments of the present disclosure can be implemented separately or in combination with other embodiments as permitted by the scheme.

Those ordinarily skilled in the art may realize that, units and algorithm steps of the examples described in the disclosed embodiments can be implemented by electronic hardware, or a combination of the computer software or the electronic hardware. Whether these functions are executed in a mode of the hardware or the software depends on particular applications and design constraint conditions of the technical schemes. Professional technicians may use different methods to implement the described functions for each particular application, but such implementation is not to be regarded beyond the scope of the present disclosure.

Those skilled in the art may clearly understand that, for the convenience and simplicity of description, a working process of the described system, apparatus and unit may refer to the corresponding process in the method embodiments, and will not be repeated.

The above is merely a implementation of the present disclosure, but the scope of protection of the present disclosure is not limited to this. Changes or replacements that may be easily thought of by technical personnel familiar with the technical field within the technical scope disclosed in the present disclosure needs to be covered within the scope of protection of the present disclosure. Thus, the scope of protection of the present disclosure needs to be subjected to the scope of protection of the claims.

1. A sidelink (SL)_communication method, performed by user equipment (UE), the SL communication method comprising:
obtaining configuration information, wherein the configuration information comprises time frequency resource information of a first SL resource pool for a first radio access technology (RAT) and a second SL resource pool for a second RAT on a first carrier, the first SL resource pool does not support a physical sidelink feedback channel (PSFCH), the second SL resource pool supports the PSFCH, and the first SL resource pool and the second SL resource pool overlap in a time domain; and
not transmitting, according to the configuration information, the PSFCH within a time unit where the first SL resource pool and the second SL resource pool overlap in the time domain.

2. The SL communication method according to claim 1, further comprising:
configuring the second SL resource pool to have no PSFCH resource within the time unit where the first SL resource pool and the second SL resource pool overlap in the time domain.

3. The SL communication method according to claim 1, further comprising:
canceling PSFCH transmission in the second SL resource pool within the time unit where the first SL resource pool and the second SL resource pool overlap in the time domain.

4. The SL communication method according to claim 3, wherein canceling the PSFCH transmission in the second SL resource pool comprises:
abandoning transmitting of the PSFCH; and
discarding information carried by the PSFCH.

5. The SL communication method according to claim 3, wherein canceling the PSFCH transmission in the second SL resource pool comprises:
transmitting a physical sidelink control channel (PSCCH) or a physical sidelink share channel (PSSCH) according to absence of PSFCH resources.

6. The SL communication method according to claim 3, wherein canceling the PSFCH transmission in the second SL resource pool comprises:
abandoning receiving of the PSFCH; and
setting received information carried by the PSFCH as a specific value.

7. The SL communication method according to claim 6, wherein abandoning the receiving of the PSFCH and setting the received information carried by the PSFCH as the specific value, comprises:
setting the specific value as ACK in a case that the PSFCH is used to carry hybrid automatic repeat request feedback information (HARQ-ACK); or setting the specific value as not indicating that collision occurs in a case that the PSFCH is used to carry inter-UE coordination information.

8. The SL communication method according to claim 3, wherein canceling the PSFCH transmission in the second SL resource pool comprises:
abandoning transmitting of the PSFCH, and transmitting information carried by the PSFCH through a physical layer channel multiplexed with a physical sidelink control channel (PSCCH) or a physical sidelink share channel (PSSCH) in a frequency domain.

9. The SL communication method according to claim 3, wherein canceling the PSFCH transmission in the second SL resource pool comprises:
abandoning transmitting of the PSFCH, and transmitting information carried by the PSFCH through a physical sidelink control channel (PSCCH) or a physical sidelink share channel (PSSCH).

10. The SL communication method according to claim 1, wherein obtaining the configuration information comprises:
obtaining the configuration information by reading pre-configured data for the UE; or
obtaining the configuration information by receiving downlink control information transmitted by a network device.

11. (canceled)

12. A communication device, comprising: a transceiver; a memory; and
a processor, connected with the transceiver and the memory and configured to control wireless signal receiving and transmitting of the transceiver by executing computer-executable instructions stored on the memory to:
obtain configuration information, wherein the configuration information comprises time frequency resource information of a first sidelink (SL) resource pool for a first radio access technology (RAT) and a second SL resource pool for a second RAT on a first carrier, the first SL resource pool does not support a physical sidelink feedback channel (PSFCH), the second SL resource pool supports the PSFCH, and the first SL resource pool and the second SL resource pool overlap in a time domain; and
not transmit, according to the configuration information, the PSFCH within a time unit where the first SL resource pool and the second SL resource pool overlap in the time domain.

13. A non-transitory computer readable storage medium storing computer-executable instructions, wherein the computer-executable instructions, when executed by a processor, cause the processor to:
obtain configuration information, wherein the configuration information comprises time frequency resource information of a first sidelink (SL) resource pool for a first radio access technology (RAT) and a second SL resource pool for a second RAT on a first carrier, the first SL resource pool does not support a physical sidelink feedback channel (PSFCH), the second SL resource pool supports the PSFCH, and the first SL resource pool and the second SL resource pool overlap in a time domain; and
not transmit, according to the configuration information, the PSFCH within a time unit where the first SL resource pool and the second SL resource pool overlap in the time domain.

14. The communication device according to claim 12, wherein the processor is further configured to:
configure the second SL resource pool to have no PSFCH resource within the time unit where the first SL resource pool and the second SL resource pool overlap in the time domain.

15. The communication device according to claim 12, wherein the processor is further configured to:
cancel PSFCH transmission in the second SL resource pool within the time unit where the first SL resource pool and the second SL resource pool overlap in the time domain.

16. The communication device according to claim 15, wherein the processor is further configured to:
abandon transmitting of the PSFCH; and
discard information carried by the PSFCH.

17. The communication device according to claim 15, wherein the processor is further configured to:
transmit a physical sidelink control channel (PSCCH) or a physical sidelink share channel (PSSCH) according to absence of PSFCH resources.

18. The communication device according to claim 15, wherein the processor is further configured to:
abandon receiving of the PSFCH; and
set received information carried by the PSFCH as a specific value.

19. The communication device according to claim 18, wherein the processor is further configured to:
set the specific value as ACK in a case that the PSFCH is used to carry hybrid automatic repeat request feedback information (HARQ-ACK); or
set the specific value as not indicating that collision occurs in a case that the PSFCH is used to carry inter-UE coordination information.

20. The communication device according to claim 15, wherein the processor is further configured to:
abandon transmitting of the PSFCH, and transmit information carried by the PSFCH through a physical layer channel multiplexed with a physical sidelink control channel (PSCCH) or a physical sidelink share channel (PSSCH) in a frequency domain.

21. The communication device according to claim 15, wherein the processor is further configured to:
abandon transmitting of the PSFCH, and transmit information carried by the PSFCH through a physical sidelink control channel (PSCCH) or a physical sidelink share channel (PSSCH).
